(19) United States
(12) Patent Application Publication
(10) Pub. No.: US 2008/0106899 A1
(43) Pub. Date: May 8, 2008

(54) Direct backlight module

(75) Inventors: Wen-Feng Cheng, Jhongli Industrial Park (TW); Yu-Chin Hsiao, Jhongli Industrial Park (TW); Pi-Ta Huang, Jhongli Industrial Park (TW)

Correspondence Address: TROXELL LAW OFFICE PLLC;Suite 1404, 5205 Leesburg Pike, Falls Church, VA, 22041, US

(73) Assignee: Entire Technology Co., Ltd.

(21) Appl. No.: 11/592,235

(22) Filed: Nov. 3, 2006

(51) Int. Cl. F21V 7/00

(52) U.S. Cl. 362/247

(57) ABSTRACT

A direct backlight module comprises a reflecting cover, several light sources disposed inside the reflecting cover, a base plate disposed above the light sources, and a microstructure formed on a light-ejecting surface or a light-injecting surface of the base plate. By using the reflecting cover, the base plate, and the microstructure, the half viewing angle can be confined and the intensity at 0° viewing angle can be obviously increased. In addition, the advantages including high light transmission rate, promoted brightness and uniform light beams can be provided by using the above-mentioned structures.

### FIELD OF THE INVENTION

The present invention relates to a diffuser plate having a surface microstructure, and more particularly to a diffuser plate that utilizes a base plate, a microstructure, and an arc-shaped reflecting cover to provide many advantages including high light transmission rate, promoted brightness and uniform light beams.

### BACKGROUND OF THE INVENTION

The general direct backlight module cannot satisfy the requirement of providing uniform brightness in the absence of optical film. It means that the brightness distribution of the backlight module is very poor when the human eyes look at different positions of the backlight module. It is apprehensible that the upper light beams of the lamp are allowed to enter the eyes directly, but the farther light beams can not be diffused to the dark region beside the lamp and the light beams can not be focused into the retinas of the eyes. This backlight phenomenon of extreme non-uniform brightness is usually called as MURA defects. A diffuser plate and a diffuser film are essential for the direct backlight module to improve the MURA defects caused by the non-uniform light source or lamp.

The diffuser plate of the current direct backlight module is generally made of a transparent polymer having diffusion particles doped therein. Moreover, the semi-sphere (or called as lenticular) refraction structure is further formed on the light-ejecting surface and the light-injecting surface of the diffuser plate so as to improve diffusion effect. But, the aberration usually exists in the semi-sphere microstructure and the light beams emitted from the light sources cannot enter the retinas. As a result, the diffusion angle of the light beam is so large that the human eyes can only sense partial brightness because the human eyes have limited filed of view.

The interval among the lamps is increased while the amount of the lamps in the 32 inches LCD TV is decreased, for example, from sixteen lamps to twelve lamps. As a result, the thickness of the backlight module must be increased so as to increase the diffusion and reduce the MURA defects instead of merely utilizing the diffusion particles and the arc-shaped reflecting structure. However, the increase of thickness violates the purpose of forming thinner backlight module. Therefore, in order to reduce the amount of the lamp and the size and weight of the backlight module, a new design must be introduced into the future diffuser plate so as to allow the light beams to enter the eyes and to maintain a certain amount of brightness and uniformity.

### SUMMARY OF THE INVENTION

A main object of the present invention is to form a microstructure on a light-ejecting surface or a light-injecting surface of the base plate so as to confine the half viewing angle and increase the intensity at 0° viewing angle, wherein the microstructure is formed in accordance with the design principle of the Fresnel lens and the Snell's law. For the purpose of maintaining the uniformity of the light beams that pass through the base plate, the special arc-shaped reflecting cover is utilized to reflect partial light beams emitted from the light sources to the base plate so that the half viewing angle can be confined to ±10 degrees. In addition, the intensity at 0° viewing angle is obviously increased by 125%.

### BRIEF DESCRIPTION OF THE DRAWINGS

FIG. 1 is a side view showing a first preferred embodiment of a direct backlight module of the present invention.

FIG. 2 is a partial enlarged view showing a base plate and a microstructure formed on the base plate in accordance with the first preferred embodiment of the present invention.

FIG. 3 is a side view showing a second preferred embodiment of a direct backlight module of the present invention.

FIG. 4 is a partial enlarged view showing a base plate and a microstructure formed on the base plate in accordance with the second preferred embodiment of the present invention.

FIG. 5 is a curve diagram showing the horizontal view angle comparison between the direct backlight module of the present invention and the direct backlight module of the prior art.

### DETAILED DESCRIPTION OF THE PREFERRED EMBODIMENT

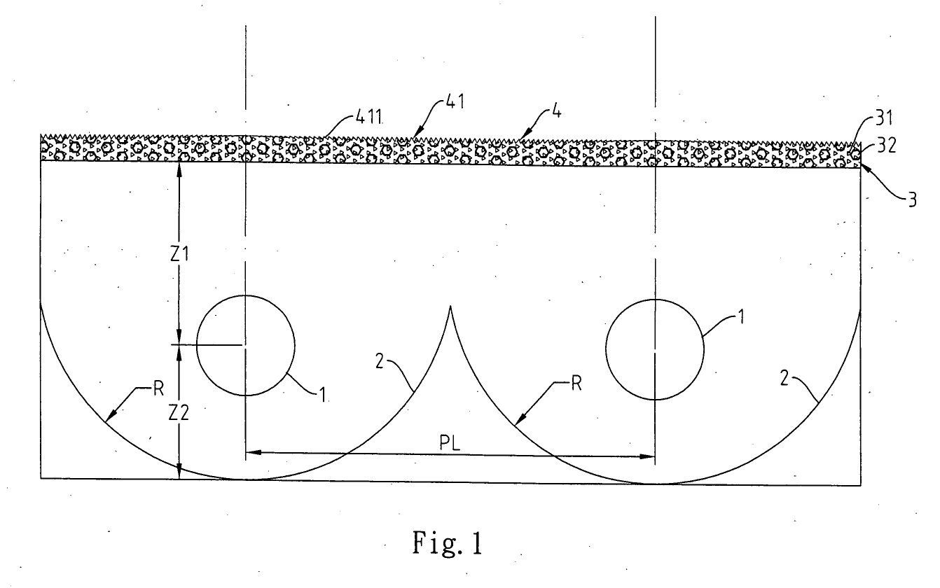

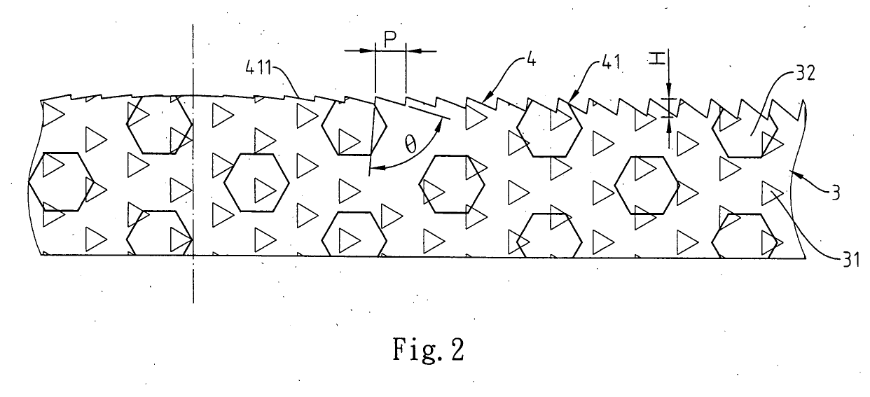

Referring to FIG. 1 and FIG. 2, a first preferred embodiment of a direct backlight module of the present invention comprises: several light sources 1, a reflecting cover 2, a base plate 3, and a microstructure 4.

The light sources 1 are Cold Cathode Fluorescent Lamps (CCFLs) or LED arrays. These light sources 1 are equally separated by a certain interval PL.

The reflecting cover 2 has continuously linked arcs having a radius of 0.5 to 0.75 times the interval PL. The aforesaid light sources 1 are held in the reflecting cover 2. The reflecting cover 2 is made of a material selected from a group consisting of polymethylmethacrylate (PMMA), polycarbonate (PC), methylmethacrylate styrene (MS), polystyrene (PS), Al, Ag, Ni, Cu, and Sn. The reflecting cover 2 is designed for reflecting partial light beams emitted from the light sources 1 so as to further focus the light beams.

The base plate 3 is disposed above the light sources 1, and it is made of a light-transmitting polymer including polymethylmethacrylate (PMMA), polycarbonate (PC), methylmethacrylate styrene (MS), or polystyrene (PS). The base plate 3 has a UV absorbent 31 doped therein to prevent the direct UV light irradiation from causing the base plate 3 to generate the phenomena of photo yellowing and cracking. In addition, the base plate 3 has several diffusion particles 32 doped therein, wherein the diffusion particles 32 are selected from a group consisting of polymethylmethacrylate (PMMA), polycarbonate (PC), methylmethacrylate styrene (MS), polystyrene (PS), silica, silicon, melamine, calcium carbonate, Teflon, TiO₂ and SiO₂. As a result, the phenomenon of optical diffusion occurs when the light passes through the diffusion particles 32.

The microstructure 4 is formed on a light-ejecting surface or a light-injecting surface of the aforesaid base plate 3. The microstructure 4 comprises several superfine patterns 41. These patterns 41 have several curved parts 411 that have different widths P, different angles θ, and different corresponding depths H from one another. The widths P of the curved parts 411 are ranged between 0.05 mm and 0.5 mm. The curved parts 411 have different angles θ, which are designed in accordance with the same design principle of the Fresnel lens. The parameters required for designing the curved parts 411 are decided by the amount N of the afore-mentioned light sources 1, the interval PL between two light sources 1, the first distance Z1 between the light source 1 and the base plate 3, and the second distance Z2 between the light source 1 and the reflecting cover 2. The interval PL is defined as a period. The lens has a back focal length defined to be the first distance Z1 plus the second distance Z2. Besides, the lens has a front focal length defined to be an infinite distance. In addition, the angles θ of the curved parts 411 are defined in accordance with the Snell's Law. In other words, if there are N light sources in the backlight module, the microstructure 4 has N periodical patterns 41, wherein the change rates of the angles θ of the curved parts 411 within the same period are all the same. Referring to FIG. 2, the centers of the curved parts 411 are disposed above the light source 1. The angles θ of the curved parts 411 are ranged from 0° to 70°. The corresponding depths H of the curved parts 411 are ranged from zero to one times the widths P of the curved parts 411.

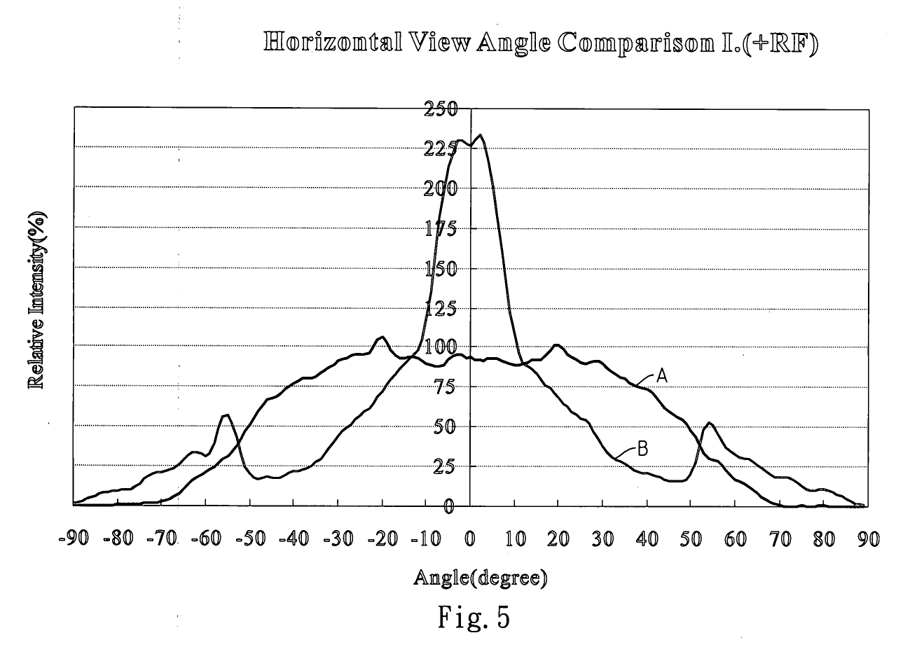

Referring to FIG. 5, a curve diagram is shown, wherein the curve A and the curve B are the conventional direct backlight module and the direct backlight module of the first preferred embodiment of the present invention, respectively. In addition, a brightness measurement equipment (for example, model Topcon BM7-fast) is utilized to measure the final brightness and uniformity of the conventional direct backlight module and the direct backlight module of the first preferred embodiment of the present invention. The measurement result shows that the present invention can confine the half viewing angle to ±10 degrees. The intensity at 0° viewing angle is obviously increased by 125%.

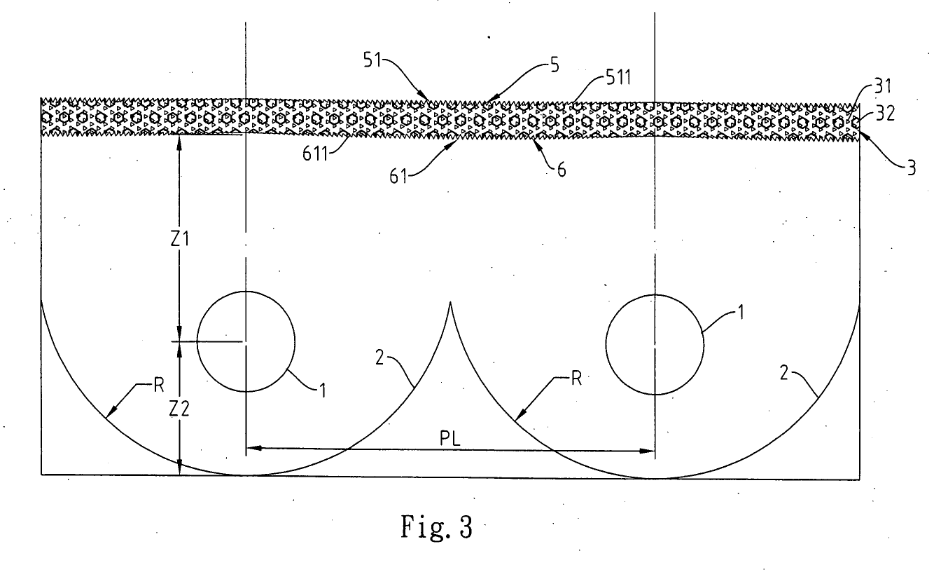

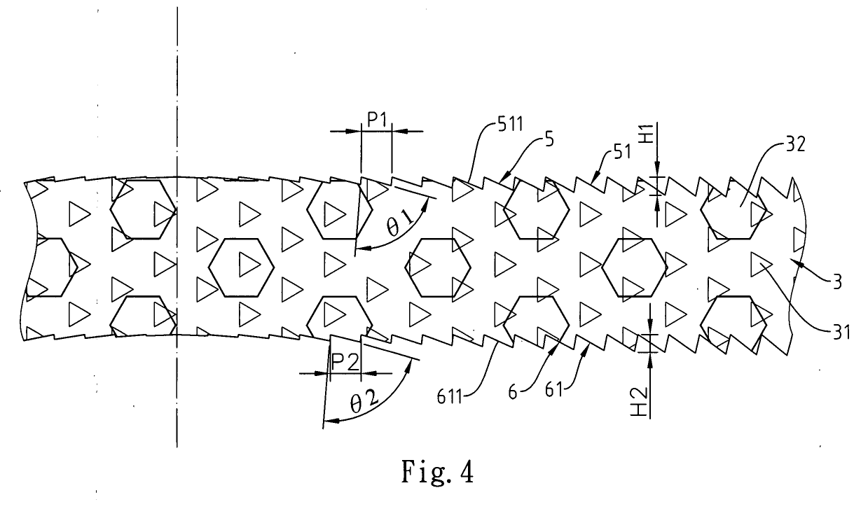

Referring to FIGS. 3 and 4, a direct backlight module of a second preferred embodiment of the present invention is basically identical to that of the first preferred embodiment of the present invention. The difference is that the microstructures 5 and 6 of the second preferred embodiment are formed on the light-ejecting surface and the light-injecting surface of the base plate 3, respectively. In other words, the microstructure 4, which is formed on the single surface of the base plate 3, is replaced with the microstructures 5 and 6, which are formed on two surfaces of the base plate 3. The respective widths P1 and p2 of the curved parts 511 and 611 are ranged between 0.05 mm and 0.5 mm. For the purpose of preventing the formation of the interference, the width P1 can be equal or unequal to the width P1. The angles θ1 and θ2 of the curved parts 511 and 611 are ranged from 0° to 40°. The corresponding depths H of the curved parts 511 and 611 are ranged from zero to 0.5 times the widths P1 and P2 of the curved parts 511 and 611.

By using the aforesaid technology, the second preferred embodiment of the present invention has the following advantages: (1) the second preferred embodiment can control the directions of the light beams better than the first preferred embodiment by using the dual-surface microstructures 5 and 6; (2) the dual-surface microstructures 5 and 6 of the second preferred embodiment can share the excessive large angle caused by the single-surface microstructure 4 of the first preferred embodiment, which causes excessive depth and affects the ability to demold. As a result, by using the dual-surface microstructures 5 and 6 of the second preferred embodiment, the optical property can be maintained while the structure's depth is half reduced.

It deserves to be specially noted that the microstructures 4, 5, and 6 of the first and second preferred embodiments can be formed by extrusion, co-extrusion, and ejection process. The thickness of the base plate 3 is ranged between 0.08 mm and 3.0 mm. The base plate can be a single layer or a sandwich structure by using the extrusion process or the co-extrusion process. The sandwich structure can be divided into core and sub layers. The total thickness of the diffuser plate is ranged from 0.08 mm to 3.0 mm. The thickness of the sub layer is ranged from 50 μm to 200 μm.

1. A direct backlight module comprising:
a plurality of light sources, which are equally separated by a certain interval;
a reflecting cover having continuously linked arcs for holding said light sources therein;
a base plate disposed above said light sources, said base plate being made of a light-transmitting polymer; and
a microstructure formed in both a light-ejecting surface and a light-injecting surface of said base plate, said microstructure having a plurality of patterns,
wherein said patterns have a plurality of curved parts that have different widths, different angles, and different corresponding depths from one another.

2. The direct backlight module of claim 1, wherein said light sources are Cold Cathode Fluorescent Lamps (CCFLs) or LED arrays.

3. The direct backlight module of claim 1, wherein said arcs of said reflecting cover have a radius of 0.5 to 0.75 times said interval.

4. The direct backlight module of claim 1, wherein said reflecting cover is made of a material selected from a group consisting of polymethylmethacrylate (PMMA), polycarbonate (PC), methylmethacrylate styrene (MS), polystyrene (PS), Al, Ag, Ni, Cu, and Sn.

5. The direct backlight module of claim 1, wherein said light-transmitting polymer is a material selected from a group consisting of polymethylmethacrylate (PMMA), polycarbonate (PC), methylmethacrylate styrene (MS), or polystyrene (PS).

6. The direct backlight module of claim 1, wherein said base plate has a UV absorbent doped therein.

7. The direct backlight module of claim 1, wherein said base plate has a plurality of diffusion particles doped therein.

8. The direct backlight module of claim 7, wherein said diffusion particles are selected from a group consisting of polymethylmethacrylate (PMMA), polycarbonate (PC), methylmethacrylate styrene (MS), polystyrene (PS), silica, silicon, melamine, calcium carbonate, Teflon, TiO₂ and SiO_{2.}

9. (canceled)

10. The direct backlight module of claim 1, wherein said curved parts are ranged from 0.05 mm to 0.5 mm.

11. The direct backlight module of claim 1, wherein said angles of said curved part are ranged from 0 to 70°.

12. The direct backlight module of claim 1, wherein said corresponding depths of said curved part are ranged from zero to one times said widths of said curved parts.
